(19) United States
(12) Patent Application Publication
(10) Pub. No.: US 2012/0168662 A1
(43) Pub. Date: Jul. 5, 2012

(54) VACUUM VALVE WITH PROTECTED SEALING SURFACE

(75) Inventor: Steven C. Borichevsky, Bloucester, MA (US)

(73) Assignee: VARIAN SEMICONDUCTOR EQUIPMENT ASSOCIATES, INC., Gloucester, MA (US)

(21) Appl. No.: 12/982,754

(22) Filed: Dec. 30, 2010

(51) Int. Cl. F16K 1/36; B23P 19/00; F16K 3/00

(52) U.S. Cl. 251/325; 251/326; 29/428

(57) ABSTRACT

A valve assembly disposed within a vacuum environment which is configured to protect the sealing surfaces thereof to prolong life of the valve assembly. The valve assembly includes a sealing piston and a flange portion that define a passage therethrough. The sealing piston is movable toward and away from the flange portion to define a chamber. When the valve assembly is in an open position, a valve seal attached to the sealing piston engages a surface of the flange portion. When the valve assembly is to be closed, the sealing piston is displaced away from the flange portion which disengages the valve seal from the surface of the flange and a gate is disposed within the space defined between the sealing piston and the flange portion. The gate includes a gate seal which engages the surface of the flange portion when the gate is disposed within the chamber.

### BACKGROUND OF THE INVENTION

1. Field of the Invention

Embodiments of the present disclosure relate to the field of valves used in vacuum environments. More particularly, the present invention relates to a valve assembly having sealing surfaces protected from deposits and contaminants which may compromise vacuum seals and lead to premature valve failure.

2. Discussion of Related Art

Vacuum environments are used in various types of processing systems especially in semiconductor fabrication where the vacuum prevents airborne contaminants from jeopardizing device manufacture. One type of process that is used to fabricate semiconductor devices is ion implantation. Ion implantation is used to dope impurity ions into a semiconductor substrate to obtain desired device characteristics. An ion implanter tool generally includes an ion source chamber which generates ions of a particular species, a series of beam line components to control the ion beam and a platen to secure a wafer or substrate that receives the ion beam.

These valves may be used to connect various vacuum chambers within the same processing tool. For example, in an ion implanter one or more valves may be disposed along the beam line component path and may be used to isolate chambers of the ion implanter. In an open state, the beam is free to propagate down the beam line path. In a closed state, sections of the beam line path may be isolated for maintenance procedures or for isolating particular regions or portions of the implanter to maintain pressures differentials.

When various dopant types are implanted into a substrate, different feed gases are supplied to the ion source chamber to obtain ion beams having particular dopant characteristics. For example, the introduction of phosphine (PH₃) fed into the source chamber is used to obtain phosphorous ion species corresponding to N-type dopants. The introduction of BF₃ into the ion source chamber is used to obtain Boron (B) ion species corresponding to P-type dopants. However, when an ion beam formed by these ion species is extracted from the ion source chamber, various surfaces of the beam line components are exposed to process contamination. In particular, particulates may deposit on the various components of valve assemblies disposed along the ion beam path. These particulates may contaminate the seals and seats of the valve assemblies causing premature valve failures which may compromise the vacuum processing environment. When valves used in vacuum environments fail, they require expensive replacement and more importantly, equipment downtime which negatively impacts device manufacturing through-put. Accordingly, there is a need for improved methods and apparatus for protecting the seals and seats of valve assemblies used in vacuum environments.

### SUMMARY OF THE INVENTION

Exemplary embodiments of the present invention are directed to a valve assembly having sealing surfaces protected from deposits and contaminants which may compromise vacuum seals and lead to premature valve failure. In an exemplary embodiment, a valve assembly includes a piston housing, a sealing piston, a valve seal, a flange portion, a transverse gate chamber and a gate. The sealing piston has a coaxial through-passage capable of displacement within the piston housing. The valve seal is disposed around the coaxial through-passage of the sealing piston. The flange portion has a coaxial through passage aligned with the coaxial through passage of the sealing piston. The transverse gate chamber is formed between the sealing piston and the flange portion. The gate is capable of displacement within the transverse gate chamber to define a closed position. The sealing piston may be displaced away from the flange portion to allow the gate to be displaced within the transverse gate chamber. The gate is capable of removal from the transverse gate chamber to define an open position where the sealing piston is displaced toward the flange portion to engage the valve seal with a surface of the flange.

In another exemplary embodiment, a method for protecting sealing surfaces of a valve assembly in a vacuum environment includes mounting a valve assembly within a vacuum environment along a propagation path of a process media. The valve assembly includes a sealing piston and a flange portion that define a passage through the valve assembly for the process media. A valve seal is disposed around the passage of the sealing piston and configured to engage a surface of the flange portion when the valve assembly is in an open position. The sealing piston is displaced toward the flange portion to engage a surface of the valve seal with the surface of the flange portion to define an open position of the valve assembly such that the surface of the valve seal is not exposed to the process media. The sealing piston is displaced away from the surface of the flange portion to define a chamber therebetween when the valve assembly is to be closed. A gate is disposed within the chamber wherein a first surface of the gate provides a seat for the valve seal. A gate seal, attached to a second surface of the gate, engages the surface of the flange portion when the valve assembly is in the closed position. In this manner, the sealing surfaces of both the valve seal and the gate seal are protected from exposure to the process media which avoids deterioration of these surfaces and prolongs usable life of the valve assembly.

### BRIEF DESCRIPTION OF THE DRAWINGS

FIG. 1 is a block diagram of an exemplary ion implant tool in accordance with an embodiment of the present disclosure.

FIG. 2 is a side block diagram of a portion of the exemplary ion implant tool of FIG. 1 including a gate valve assembly in accordance with an embodiment of the present disclosure.

FIG. 3 is a schematic side view of an exemplary valve assembly in accordance with an embodiment of the present disclosure.

FIG. 4A-4C illustrates a side view of an exemplary sequence of various positions in accordance with an embodiment of the present disclosure.

FIG. 5 is a cross sectional perspective view of the gate valve assembly in an open position in accordance with an embodiment of the present disclosure.

FIG. 6 is a cross sectional perspective view of the gate valve assembly in a closed position in accordance with an embodiment of the present disclosure.

### DESCRIPTION OF EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

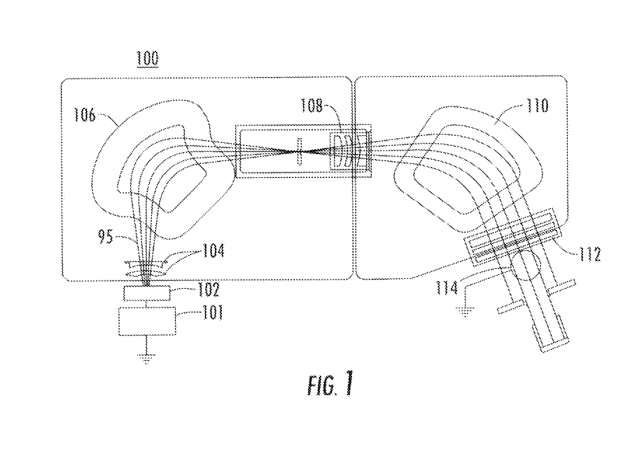

FIG. 1 is a block diagram of an exemplary ion implant tool 100 that provides the necessary ion dosage levels with associated energy levels to permit implants into a work piece. Implanter 100 includes an ion source chamber 102 which typically includes a heated filament powered by power supply 101 to ionize a feed gas introduced into the chamber to form charged ions and electrons (plasma).

Different feed gases are supplied to the source chamber to generate ions having particular dopant characteristics. The ions are extracted from source chamber 102 via a standard extraction electrode assembly 104 to form ion beam 95. Beam 95 passes through a mass analyzer chamber 106 having a magnet which functions to pass only ions having the desired charge-to-mass ratio to a resolving aperture. In particular, analyzer magnet includes a curved path where beam 95 is exposed to the applied magnetic field which causes ions having the undesired charge-to-mass ratio to be deflected away from the beam path. Deceleration stage 108 includes a plurality of electrodes which outputs a diverging ion beam. A corrector or collimator magnet chamber 110 is positioned downstream of deceleration stage 108 and is configured to deflect the ion beam 95 into a ribbon beam having parallel trajectories. The beam is targeted toward a work piece which is attached to a support or platen 114. An additional deceleration stage 112 may also be utilized which is disposed between collimator magnet chamber 110 and support 114. Typically, the ion source chamber 102 is at a relatively low vacuum and the remaining components of implant tool 100 are at a relatively higher vacuum level.

FIG. 2 is a block diagram of a portion of ion implant tool 100 including a gate valve assembly 200 disposed between ion extraction electrodes 104 and mass analyzer chamber 106. Ion source 102 may be designated as a low vacuum portion 100a and the extraction electrodes 104 and mass analyzer chamber may be designated as a high vacuum portion 100b. Additional components of ion implant tool 100 may also be included in high vacuum operation as noted above. Typically, the purpose of valve assembly 200 disposed between portions 100a and 100b is to isolate these portions during maintenance and to leave the valve assembly open during operation. For example, portion 100a may be open to ambient atmosphere during a maintenance procedure while section 100b is maintained at high vacuum. Although gate valve assembly 200 is depicted as being disposed along the beam line between the ion source chamber 102 and mass analyzer chamber 106, this is done for explanatory purposes only and alternative positions and configurations of the gate valve assembly may be employed in ion implanters, plasma doping (PLAD) tools as well as other processing systems where contamination of valve seals inside or outside of vacuum environments is desired.

As noted above, ion source 102 is used to generate ions which are extracted therefrom and implanted into a substrate or workpiece. In this example, the extracted ions are the process media that form a beam 95 which travels through a pathway defined by gate valve assembly 200 along a “Z” axis. When the valve assembly is in an open position, beam 95 propagates toward mass analyzer chamber 106. Consequently, these components are exposed to byproducts of the various ions that form beam 95 such as, for example, Boron, As, P205, C, etc. Over time, these byproducts leave deposits or particulates along the interior surfaces of valve assembly 200 as well as the seals that provide a vacuum seal for the valve. In particular, this build up of particulates may deposit on the sealing surface of the valve causing premature valve failures either by compromising the seal of the valve seat or the gate seal. Moreover, this contamination on the sealing surfaces that prevents the ability to seal the valve may preclude the ability to isolate the respective chambers during maintenance procedures. By protecting the sealing surfaces of both the gate and valve seals of valve assembly 200 from the path of ion beam 95 (or plasma in a PLAD tool), this valve assembly of the present disclosure isolates components within the implanter 100, but avoids potential valve failures as well as downtime associated with valve or seal replacements which may negatively impact process throughput.

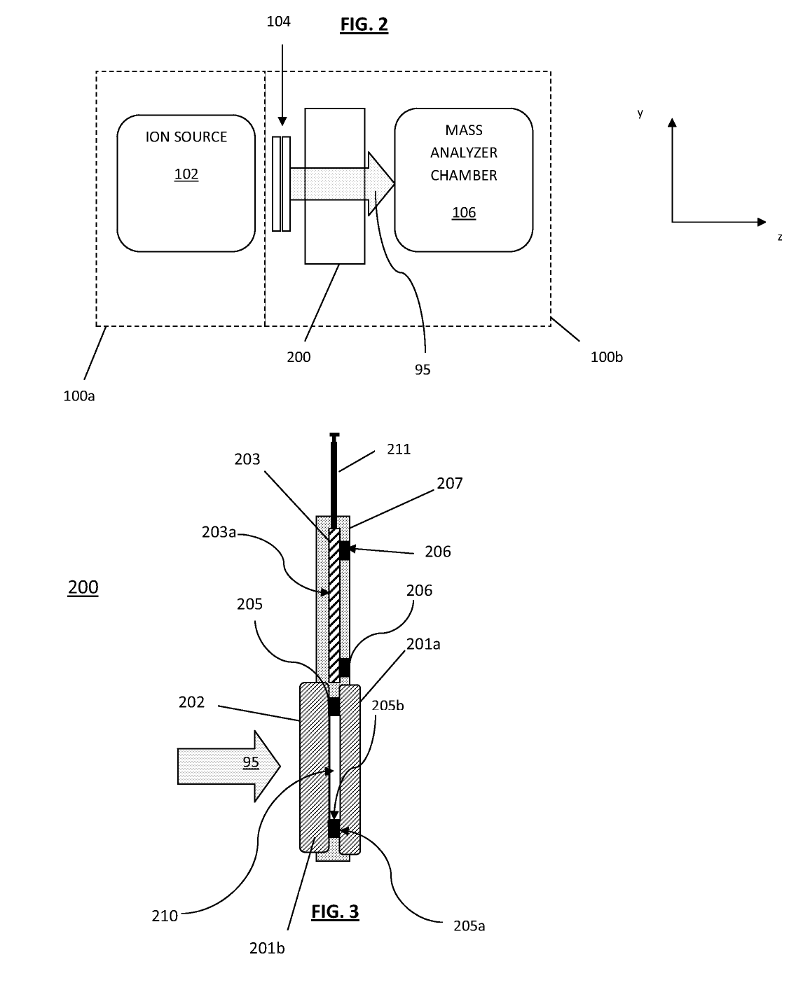

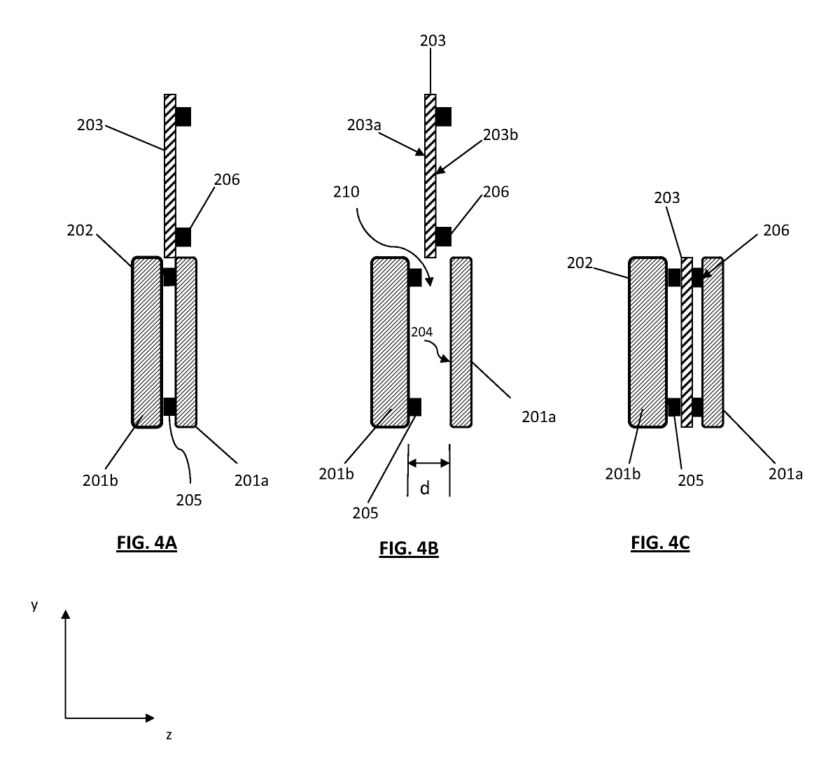

FIG. 3 is a schematic side view of valve assembly 200 which comprises a gate valve housing defined by opposed first half which is a flange 201a and a second half which is sealing piston 201b. The sealing flange 201a and sealing piston 201b each have coaxial through-passages along the Z axis through which the extracted ion beam 95 propagates. The piston 201b and flange 201a may have a generally circular shape with a valve seal 205 attached to piston 201b around the circumference of the valve housing. Valve seal 205 may be made from a deformable body of elastomeric material such as natural rubber or other suitable synthetic elastomer. Flange 201a is configured to receive seal 205 when the valve is in an open position. In particular, valve piston 201b is disposed within piston housing 202 which forces piston 201b in the Z direction to engage seal 205 against flange 201a. The piston housing 202 is pressurized to force the sealing piston 201b onto an opposing surface or seat of flange 201a. This forces surface 205a of seal 205 to engage a surface of flange 201a. Seal 205 also has an interior circumference surface 205b which surrounds the pathway through which ion beam 95 propagates. Since the surface 205b is the only surface of seal 205 which is exposed to ion beam 95, this is the only surface upon which particulates may deposit. However, surface 205b does not create the seal with flange 201a. Rather, surface 205a creates the seal with flange 201a. Therefore, particulates that may deposit on surface 205b do not compromise the seal formed between the seating surface (reference 204 shown in FIG. 4B) of flange 201a and sealing piston 201b.

In addition, flange 201a and piston 201b define a transverse narrow chamber or space 210 of sufficient width to allow a movable gate 203 to pass therethrough. Gate 203 is disposed within gate housing 207 to maintain the vacuum environment. Gate 203 includes a gate seal 206 which extends around the circumference of a surface 203b (see FIG. 4B) of the gate corresponding to the coaxial through-passage. Similar to valve seal 205, gate seal 206 may be made from a deformable body of elastomeric material such as natural rubber or other suitable synthetic elastomer. When the gate 203 is not disposed within the transverse gate chamber or space 210, the valve is in an open position. When the gate 203 is disposed within the transverse gate chamber 210, the valve is in a closed position. Gate 203 with gate seal 206 may have a thickness, for example, on the order of 0.5 cm, however the size and thickness of gate 203 will vary with the size of valve assembly 200.

In order to close the valve 200, sealing piston 201b is displaced by depressurizing piston housing 202 which allows piston 201b to be displaced away from flange 201a in the negative Z direction or in a direction opposite the propagation direction of beam 95. This breaks the seat of seal 205 with flange portion 201a and allows sufficient clearance for gate 203 to be disposed within transverse gate chamber 210. This closed position causes surface 206a of gate seal 206 to engage a surface of flange 201a and surface 205a of seat 205 to engage a surface 203a of gate 203 to seat the gate within transverse gate chamber 210.

Piston rod 211 which is attached to gate 203 is used to displace the gate to an open position to allow beam 95 to pass there-through and to displace the gate into transverse gate chamber 210 when in a closed position to isolate various components upstream and downstream of valve assembly 200. Piston 211 may be activated pneumatically, mechanically or other known method in order to exert a sufficient force to displace gate 203 from housing 207 into transverse gate chamber 210 to close the valve assembly 200. In this manner, the vacuum environment is maintained during the displacement of gate 203 in and out of transverse gate chamber 210.

Although the exemplary embodiments included herein refer to gate valves in which the gates are opened and closed via linear motion, it should be understood that the scope of this disclosure also includes pendulum and/or rotary gate valve configurations as well as alternatives. In these alternative configurations, known forms of actuation may be used to open and close the respective gates of the valves.

FIG. 4A-4C illustrates a side view of a sequence of various positions of flange portion 201a and sealing piston 201b with gate 203 when the valve assembly 200 goes from an open to a closed position. For example, FIG. 4A illustrates valve assembly in an open position with seal 205, which is attached to piston 201b, engaging a surface 204 of flange 201a. In this position, gate 203 is not disposed within space 210 corresponding to an open valve configuration. When valve assembly 200 is to be closed, sealing piston 201b is displaced away from flange 201a by depressurizing piston housing 202. When sealing piston 201b moves away from flange 201a a distance “d”, this breaks the seat of seal 205 with surface 204 of flange portion 201a. FIG. 4C illustrates valve assembly 200 when gate 203 is in a closed position. The displacement of sealing piston 201b by depressurizing piston housing 202 allows sufficient clearance for gate 203 to be disposed within transverse gate chamber 210. Once the gate 203 is positioned within space 10, piston housing 202 is pressurized to force sealing piston 201b against surface 203a of gate 203.

Similarly, when the gate valve assembly 200 moves to an open position, sealing piston 201b is depressurized and the seal between seal 205 and surface 203a of gate 203 is broken. The gate 203 is displaced out of space 210 and piston housing 202 is pressurized forcing sealing piston 201b toward surface 204 of flange 201a. Consequently, this forces seal 205 against surface 204 of flange 201a. Since seal 206 is disposed on surface 203b of gate 203, it is not exposed or is downstream of ion beam 95 when it moves into transverse gate chamber 210. This allows the surface of seal 205 that engages surface 204 of flange 201a to be isolated from the particulate deposits that form as a consequence of ion beam 95 propagating through valve assembly 200.

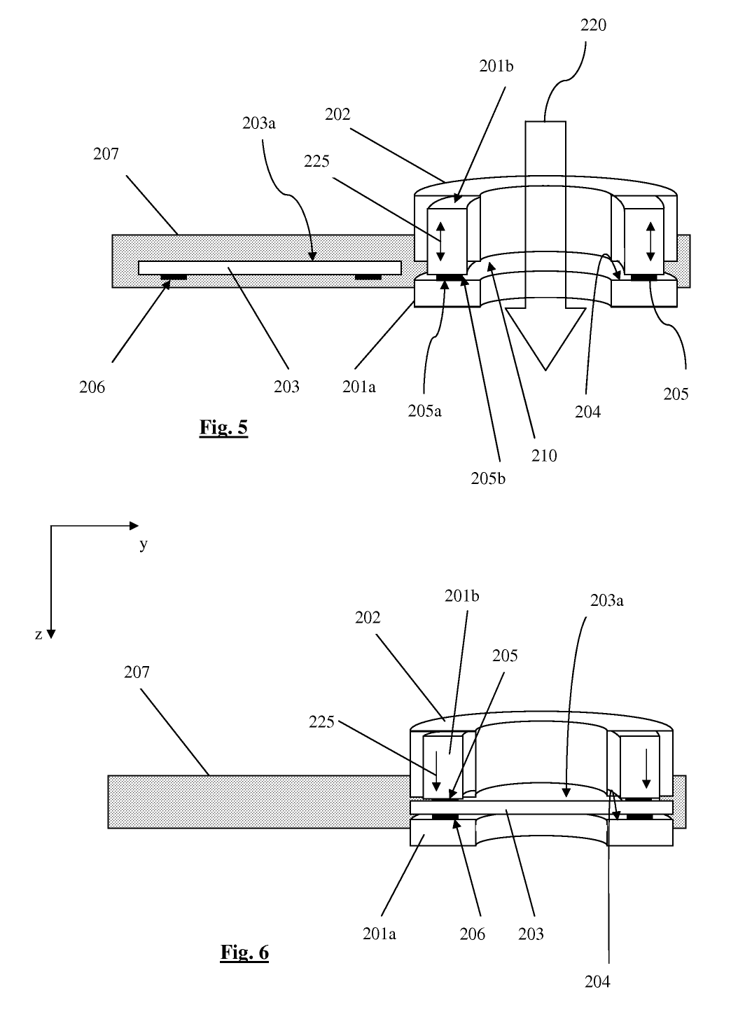

FIG. 5 is a perspective cut-away view of a valve assembly 200 in an open position. As can be seen, sealing flange 201a and sealing piston 201b have a generally circular shape defining respective coaxial through-passages to form interior pathway 220. Although sealing flange 201a and sealing piston 201b are depicted as having a circular shape, alternative configurations as well as a corresponding shape of gate 203 may also be employed using the same sealing configuration.

Sealing flange 201a and sealing piston 201b define transverse gate chamber 210 therebetween. In addition, sealing flange 201a and sealing piston 201b form interior pathway 220 along the Z axis through which an extracted ion beam 95 propagates. Seal 205 is attached around the circumference of sealing piston 201b. Sealing piston 201b is disposed within piston housing 202 and is displaced in the directions illustrated by arrows 225 by pressure within piston housing 202. For example, when piston housing 202 is pressurized, sealing piston 201b is forced toward flange portion 201a forcing surface 205a of seal 205 to engage surface 204 of flange 201a. When piston housing 202 is depressurized, sealing piston 201b is forced away from flange portion 201a releasing the seat formed by seal 205 and surface 204. In this configuration, only surface 205b of seal 205 is exposed to ion beam 95 propagating through pathway 220 of assembly 200. However, surface 205b is not the sealing surface between seal 205 and flange 201a. Rather, seating surface 205a engages surface 204 of flange 201a when the valve assembly is in an open position and surface 205a is not exposed to the ion beam. Consequently, surface 205a will not be subject to particulate deposits thereby avoiding contamination of the seat during operation of the processing tool. Gate 203 includes gate seal 206 which is disposed within gate housing 207 when the valve assembly is in an open position.

FIG. 6 is a perspective cut-away view of a valve assembly 200 in a closed position. When the valve assembly moves to a closed position, piston housing 202 is depressurized which allows valve piston to move away from flange 201a thereby breaking the seat formed between seal 205 and surface 204. Once sufficient clearance is created by the displacement of sealing piston 201b within piston housing 202, gate 203 is disposed within transverse gate chamber 210. The seal 206 of gate 203 engages surface 204 to form a seat with flange 201a. The sealing housing 202 is pressurized forcing piston 201b in the direction indicated by arrow 225 to form a seat between seal 205 and surface 203a of gate 203. Once gate 203 is disposed within transverse gate chamber 210, seal 206 of gate 203 is downstream of the propagating ion beam and is not exposed to any particulate deposits therefrom.

Similarly, when the valve assembly moves to an open position, the process is reversed. In particular, piston housing 202 is depressurized which displaces sealing piston 201b in a direction opposite to arrow 225. This releases the seats formed between seal 205 and surface 203a of gate 203 as well as allowing the seat formed between gate seal 206 and surface 204 of flange 201a to disengage when gate 203 is moved out of transverse gate chamber 210. Gate 203 then recedes into gate housing 207. Piston housing 202 is re-pressurized and sealing piston 201a is displaced again in the direction indicated by arrow 225 toward flange 201a. This allows surface 205a of seal 205 to engage surface 204 of flange 201a. The valve assembly 200 is now in an open position similar to the position shown with reference to FIG. 5.

In this manner, when the valve assembly 200 is in an open position, surface 205b of seal 205 is not exposed to ion beam 95 and associated process byproduct contamination. Similarly, when the valve assembly is in a closed position, gate seal 206 is downstream from 102 and is not susceptible to process byproduct contamination and surface 205a of seal 205 engages surface 203a of gate 203. In this manner, process byproducts that may deposit on surface of seal 205 (e.g. surface 205b) do not compromise the seal formed between flange 201a and sealing piston 201b. This allows seal 205 to be protected from process byproducts, thereby providing a more reliable vacuum seal which has a longer operational life.

While the present invention has been disclosed with reference to certain embodiments, numerous modifications, alterations and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A valve assembly comprising:
a piston housing;
a sealing piston having a coaxial through passage and capable of displacement within said piston housing;
a valve seal disposed around said coaxial through passage of said sealing piston;
a flange portion having a coaxial through passage aligned with the coaxial through passage of said sealing piston;
a transverse gate chamber formed between said sealing piston and said flange portion;
a gate capable of displacement within said transverse gate chamber to define a closed position, said sealing piston displaced away from said flange portion to allow said gate to be displaced within said transverse gate chamber, said gate capable of removal from said transverse gate chamber to define an open position, said sealing piston displaced toward said flange portion to engage said valve seal with a surface of said flange.

2. The valve assembly of claim 1 wherein said valve seal has a first surface exposed to said coaxial through passage and a second surface engaged with said surface of said flange when said valve assembly is in an open position.

3. The valve assembly of claim 1 wherein said gate includes a gate seal aligned with said coaxial through passage, said gate seal configured to engage said surface of said flange when said gate is displaced within said transverse gate chamber.

4. The valve assembly of claim 3 wherein said gate seal is disposed on a first surface of said gate, said valve seal having a first surface exposed to said coaxial through passage and a second surface engaged with a second surface of said gate, said first surface of said gate being transposed from said second surface of said gate.

5. The valve assembly of claim 1 further comprising a gate piston configured to displace said gate in and out of said transverse gate chamber.

6. The valve assembly of claim 5 further comprising a gate housing configured to house said gate when said valve assembly is in an open position.

7. The valve assembly of claim 6 wherein said gate and gate housing are maintained in a vacuum environment.

8. The valve assembly of claim 1 wherein said piston housing and said sealing piston are maintained in a vacuum environment.

9. The valve assembly of claim 1 wherein said gate seal is a deformable body of elastomer material.

10. The valve assembly of claim 3 wherein said gate seal is a deformable body of an elastomer material.

11. A valve assembly comprising:
a first and second opposed housing members each defining a through passage;
a valve seal disposed around said through passage of said first housing member;
a space defined between said first and second housing members;
a gate capable of displacement within said space to define a closed position, said first housing member displaced away from said second housing member to allow said gate to be displaced within said space and provide engagement of said valve seal with a surface of said gate, said gate capable of removal from said space to define an open position when said first housing member is displaced away from said gate, said first housing member displaced toward said second housing member to engage said seal with a surface of said second housing member.

12. The valve assembly of claim 11 wherein said valve seal has a first surface exposed to said through passage and a second surface engaged with said surface of said second housing member when said valve assembly is in an open position.

13. The valve assembly of claim 11 wherein said gate includes a gate seal aligned with said through passage, said gate seal configured to engage said surface of said second housing member when said gate is displaced within said space.

14. The valve assembly of claim 13 wherein said gate seal is disposed on a first surface of said gate, said valve seal having a first surface exposed to a portion of said through passage and a second surface engaged with a second surface of said gate, said first surface of said gate being transposed from said second surface of said gate.

15. A method of protecting sealing surfaces of a valve assembly in a vacuum environment comprising:
mounting a valve assembly within a vacuum environment along a propagation path of a process media, the valve assembly including a sealing piston and a flange portion that define a passage through said valve assembly for said process media, a valve seal disposed around said passage of said sealing piston and configured to engage a surface of said flange portion when said valve assembly is in an open position;
displacing the sealing piston toward said flange portion to engage a surface of said valve seal with said surface of said flange portion to define an open position of said valve assembly such that said surface of said valve seal is not exposed to said process media;
displacing the sealing piston away from said surface of the flange portion to define a chamber therebetween when said valve assembly is to be closed;
disposing a gate within said chamber wherein a first surface of said gate provides a seat for said valve seal; and
engaging a gate seal, attached to a second surface of the gate, with said surface of the flange portion when said valve assembly is in the closed position.

16. The method of claim 15 further comprising actuating a piston to move said gate within said chamber when said valve assembly is in a closed position and out of said chamber when said valve is in an open position.

17. The method of claim 15 wherein disposing the gate within the chamber further comprises swinging the gate about a pendulum axis to move said gate within said chamber when said valve assembly is in a closed position and out of said chamber when said valve is in an open position.
